(19) United States
(12) Patent Application Publication
(10) Pub. No.: US 2006/0278182 A1
(43) Pub. Date: Dec. 14, 2006

(54) Connection assembly for converting between reciprocal and rotary motion

(76) Inventor: Graham Harry Fountain, Neutral Bay, NSW (AU)

Correspondence Address: Abelman Frayne & Schwab, 150 East 42nd Street, New York, NY, 10017-5612, US

(21) Appl. No.: 10/513,298

(22) PCT Filed: Apr. 30, 2003
(86) PCT No.: PCT/AU03/00507

§ 371 Date: Feb. 17, 2006

(30) Foreign Application Priority Data
Apr. 30, 2002 (AU) PS 2043

(51) Int. Cl. F02B 75/24; F16C 7/00

(52) U.S. Cl. 123/55.2; 74/579 R

(57) ABSTRACT

A connection assembly for converting between reciprocal and rotary motion including opposed members (1) arranged for reciprocating motion. Each opposed member (1) have a guide surface (5) for guiding a drive block transversely of a direction of the (6, 11) to allow the members (1) to be clamped together and retained in fixed relation by frictional engagement.

### FIELD OF THE INVENTION

The invention relates to a connection assembly for converting between reciprocal and rotary motion particularly, but not exclusively, for use in converting reciprocal motion of a piston into rotary motion of a crankshaft.

### BACKGROUND OF THE INVENTION

An apparatus is disclosed in U.S. Pat. No. 5,327,863, for converting linear reciprocal motion of two opposed pistons into rotary motion of a crankshaft. The apparatus includes two reciprocating members, coupled to a respective piston, which are interconnected by connecting plates and which each define a transversely extending guide surface for a drive block to travel along. The drive block receives a rotatable crank pin, whereby movement of the members in a linear direction causes the block to track transversely between the guide surfaces to thereby impart a resultant rotational movement to the crankshaft via the crank pin.

The patent describes how prior apparatus had a disadvantage insofar as the guide surfaces were prone to deformation due to high loads being applied between the pistons and the crankshaft, such as in a vehicle engine running at high speeds. In order to address that problem, the patent provides an apparatus where the connecting plates and members are bolted together, at least at intervals along outer portions of the guide surfaces. The connecting plates and members are further disclosed as being coupled together by an interference structure in the form of a rib-and-groove arrangement, running parallel to the guide surfaces.

The physical connection of the plates to the reciprocating members is preferably as close to the central drive block as possible in a cylinder axial direction, to maximise the working stroke of the pistons for a given deck to deck dimension. Indeed, the coupling shown in U.S. Pat. No. 5,327,863 has the connecting bolts passing through the actual rib of the rib-and-groove arrangement, directly adjacent the guide surfaces. As such, quite high machining accuracy is required to produce the members and associated connecting plates to ensure proper placement of bolt holes and to allow for correct intermitting of the rib and grooves. Particular design attention is also needed to ensure transmission forces focussed about each of the connecting bolts do not adversely affect the guide surfaces, due to their close proximity. Further, in order to assist in distribution of the transmission forces, the interference structure of the rib-and-groove arrangement also needs to be accurately machined.

### OBJECT OF THE INVENTION

The invention seeks to provide an alternative force transmission assembly.

### SUMMARY OF THE INVENTION

In accordance with the invention, there is provided a connection assembly including opposed members arranged for reciprocating motion, each having a guide surface for guiding a drive block transversely of a direction of the reciprocal motion and complimentary connection pads to allow the members to be clamped together via through bores oriented 90° to said direction of the reciprocal motion and retained in fixed relation by frictional engagement.

Preferably, the connection pads are raised relative to an adjacent surface of the members.

Preferably, each member includes at least four connection pads.

Preferably, the members are clamped together by bolts arranged to pass through the connection pads and, more preferably, the bolts act as a dowel, aiding in accurate connection of the members. The dowelling feature also assists in avoiding any interruption of stress transmission through the members at a location where they are joined.

Preferably, the assembly is in the form of a connecting rod of a Scotch-Yoke engine.

In another aspect, there is provided a member for the above-described assembly adapted for reciprocating motion and including a guide surface, extending transversely of the member and connection pads and being arranged for frictional engagement with a connection complimentary pad of a second member.

The above assembly allows for transmission of forces and moments by friction and interfitting interference structure can be dispensed with as a result, which substantially simplifies construction. Further, use of connection pads allows for enhanced distribution of stress transmitted between the members and that can inturn increase the comparative working load that can be applied to the assembly.

### BRIEF DESCRIPTION OF THE DRAWINGS

The invention is described, by way of non-limiting example only, with reference to the accompanying drawings, in which:

FIG. 1 is a perspective view of a member of a connection assembly; and

FIG. 2 is a perspective view of the connection assembly.

### DETAILED DESCRIPTION OF THE INVENTION

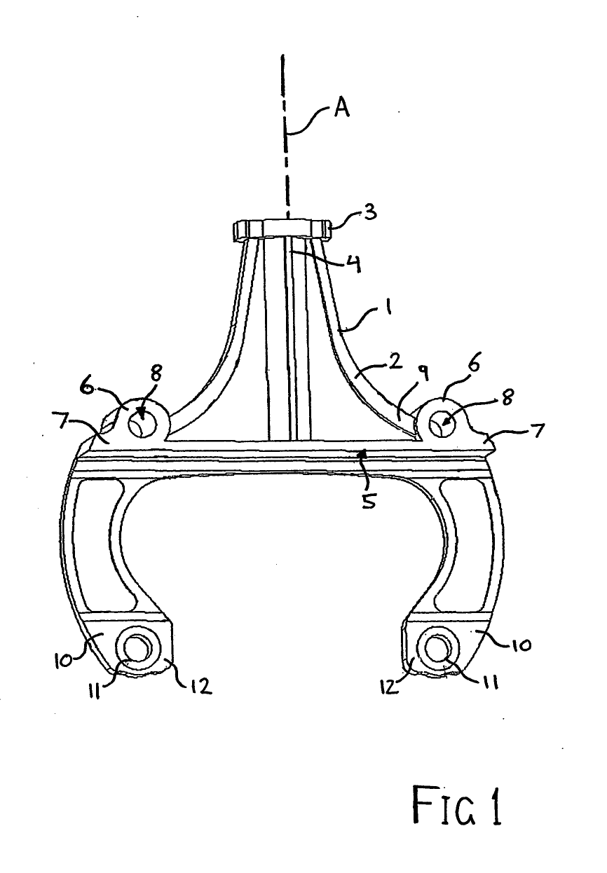

A member (1) is shown in FIG. 1 as including a main body (2) which has a coupling 20 structure (3) at one end (4) for coupling to a piston (not shown) or the like. The body (2) also defines a transverse guide surface (5) which extends substantially orthogonally to a direction of travel, indicated by reference “A”, along which the member (1) reciprocates. A connection pad (6) is provided toward either end (7) of the guide surface (5), in space relation from the guide surface (5) itself, in a direction toward the 25 coupling (3). Each connection pad (6) has a through bore (8) oriented at 90° to the direction of travel indicated by “A”, for receipt of a connecting bolt. The pads (6) are marginally raised relative to an adjacent surface (9) of the body (2).

The member (1) also includes two C-shaped arms (10) which extend away from the 30 body (2), laterally of the guide surface (5). The arms (10) each have a connection pad (11) at remote ends (12) thereof.

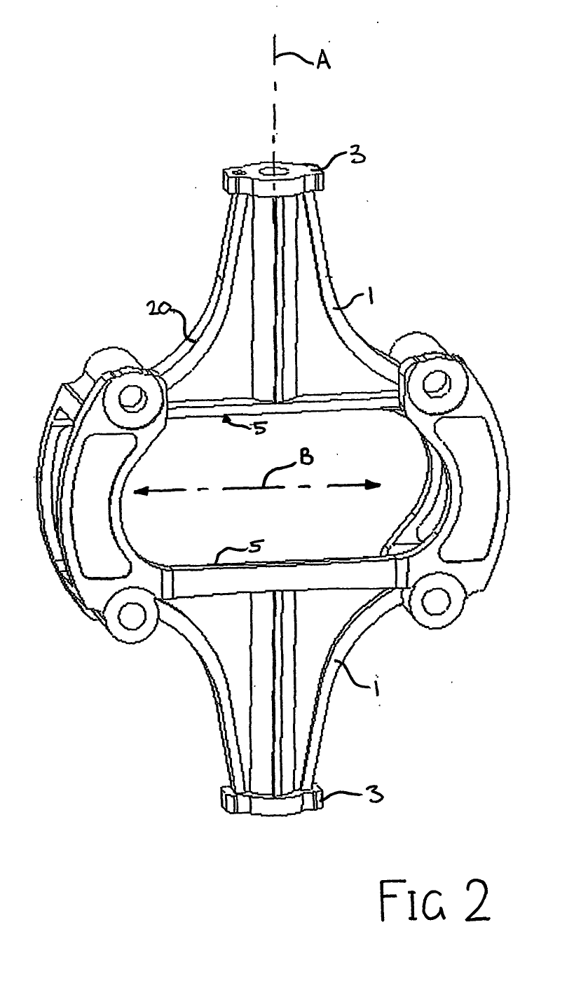

In order to form an assembly (20), as shown in FIG. 2, two members (1) which are identically formed, are coupled together by inverting one of the members relative to the other so that the respective connecting pads (11) locate over complimentary pads (6) of the other member. The assembly (20), arranged in that manner, is adapted to capture a drive block (not shown) between opposed guide surfaces (5). The members (1) may then be clamped together by any suitable means such as a bolt passing through respective bores (8) in each of the pads. Once the members are clamped together, they are retained in fixed relation by frictional engagement between the respective pads (6) and (11).

In operation, the coupling (3) of each member (1) is engaged with an associated opposed piston of a Scotch-Yoke-type engine or the like and the assembly (20) is caused to reciprocate in direction “A”. As the assembly reciprocates, the drive block is free to move transversely in direction “B” in order to impart rotary motion to a crank pin received in the drive block.

The placement of the pads (6), in spaced relation from the respective guide surface (5) does result in some restriction on the depth to which the piston can move into an associated piston housing. However, it is considered the advantages offered by the assembly design result in an overall beneficial construction. In particular, construction of the connection pads (6,11) is substantially simplified, as compared to interference structure such as the tongue-and-groove arrangement of the prior art since only the surfaces of pads (6,11) require accurate machining/grinding. The pads (6,11) are preferably formed in slightly raised relation relative to an adjacent surface of the member so that grinding can be easily effected. Further, the relatively large surface area of the pads (6,11) facilitates reliable load distribution and transfer of stress and torsional forces between the members (1). As such, deformation forces may be migrated away from the guide surfaces (5) to thereby enhance the working life of the assembly and allow for either an increase workload to be applied to the assembly or a lighter construction to be realised. The bolts used to clamp the respective pads together may also be used to provide a “dowel function” to aid in accurate connection of the members (1) and to provide uninterrupted stress transmission and further enhance distribution of loads through the assembly. Additionally, bores (8) are arranged laterally to the piston motion thus placing the bolting and clamping surfaces in direct shear and not direct tension as with conventional connecting rods.

The assembly (20) has been described with reference to converting reciprocal motion into rotary motion, however, it may also be utilised to convert rotary motion of, for example, a crank pin into reciprocal motion of the members. Further, the assembly (20) has been described by way of non-limiting example only and many modifications and variations may be made thereto without departing from the spirit and scope of the invention described.

The term “comprising” (and its grammatical variations) as used herein is used in the inclusive sense of “having” or “including” and not in the exclusive sense of “consisting only of”.

1. A connection assembly including opposed members arranged for reciprocating motion, each having a guide surface for guiding a drive block transversely of a direction of the reciprocal motion and complimentary connection pads to allow the members to be clamped together via through bores oriented 90° to said direction of the reciprocal motion and retained in fixed relation by frictional engagement.

2. A connection assembly according to claim 1, wherein the connection pads are raised relative to an adjacent surface of the members.

3. A connection assembly according to claim 2, wherein each member includes at least four connection pads.

4. A connection assembly according to claim 1, wherein the members are clamped together by bolts arranged to pass through the connection pads.

5. A connection assembly according to claim 4, wherein the bolts act as a dowel, aiding in accurate connection of the members.

6. A connection assembly according to claim 1 in the form of a connecting rod of a Scotch-Yoke engine.

7. A member for a connection assembly according to any one of the preceding claims, the member being adapted for reciprocating motion and including a guide surface extending transversely of the member and connection pads being arranged for frictional engagement with a complimentary connection pad of a second member.
